(19) United States
(12) Patent Application Publication
(10) Pub. No.: US 2009/0039538 A1
(43) Pub. Date: Feb. 12, 2009

(54) METHOD OF FORMING A THERMOPLASTIC ARTICLE

(75) Inventor: Chi Shing LAM, Kowloon (HK)

Correspondence Address: WILLIAM J. SAPONE;COLEMAN SUDOL SAPONE P.C., 714 COLORADO AVENUE, BRIDGE PORT, CT, 06605, US

(73) Assignee: Sea Profit (Hong Kong) Limited, Kowloon (HK)

(21) Appl. No.: 12/171,598

(22) Filed: Jul. 11, 2008

(30) Foreign Application Priority Data
Aug. 10, 2007 (GB) 0715672.2

(51) Int. Cl. B29C 45/16

(52) U.S. Cl. 264/74

(57) ABSTRACT

A method of forming a thermoplastic article, including the steps of (a) forming a workpiece of a thermoplastic material of a first colour by injection molding; (b) applying a second colour on the workpiece by over-molding part of the workpiece with the thermoplastic material of the second colour by injection molding; (c) raising the temperature of the workpiece to at least the forming temperature of the thermoplastic material; and (d) enlarging the workpiece by blow molding.

This invention relates to a method of forming a thermoplastic article, in particular such a method adapted to form a thermoplastic article with varied colours and/or patterns.

### BACKGROUND OF THE INVENTION

There are various methods of forming articles made of plastics, in particular thermoplastics. Although there are techniques for forming coloured patterns on such articles, the patterns so formed are rather regular, and thus lack aesthetic appeals.

It is thus an object of the present invention to provide a method of forming a thermoplastic article in which more varied colours and/or patterns may be formed on the article, thus enhancing the aesthetic appeal of the article, or at least to provide a useful alternative to the public and trade.

### SUMMARY OF THE INVENTION

According to the present invention, there is provided a method of forming a thermoplastic article, including the steps of (a) forming a workpiece of a thermoplastic material by molding; (b) applying at least one colour on said workpiece by over-molding at least part of said workpiece with said thermoplastic material of said at least one colour; (c) raising the temperature of the workpiece to at least the forming temperature of said thermoplastic material; and (d) enlarging said workpiece.

### BRIEF DESCRIPTION OF THE DRAWINGS

Preferred embodiments of the present invention will now be described, by way of example only, with reference to the accompanying drawings, in which:

FIGS. 1A to 1D show exemplary steps of a method of forming a thermoplastic article according to a preferred embodiment of the present invention;

FIG. 2A is a front view of a preform formed in the step shown in FIG. 1A;

FIG. 2B is a front view of the preform formed in the step shown in FIG. 1B;

FIG. 2C is a sectional view of the preform shown in FIG. 2B;

FIG. 3 is a front view of a bottle formed out of the preform of FIG. 2A by the method shown in FIGS. 1A to 1D;

FIG. 4 is a front view of a further preform formed in the step shown in FIG. 1A;

FIG. 5 is a front view of a bottle formed out of the preform of FIG. 4 by the method shown in FIGS. 1A to 1D;

FIGS. 6A and 6B are views of a further bottle formed by the method shown in FIGS. 1A to 1D;

FIGS. 7 to 10 are views of four further bottles formed by the method shown in FIGS. 1A to 1D;

FIG. 11A is a top of a container with a part formed by the method shown in FIGS. 1A to 1D; and

FIG. 11B is a front view of the container shown in FIG. 11A.

### DETAILED DESCRIPTION OF THE PREFERRED EMBODIMENTS

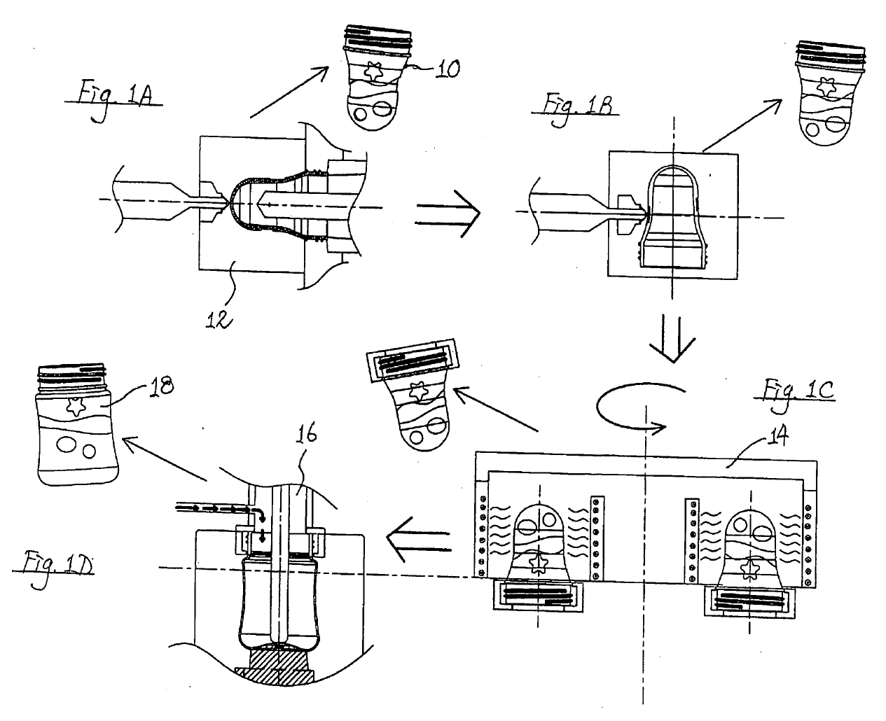

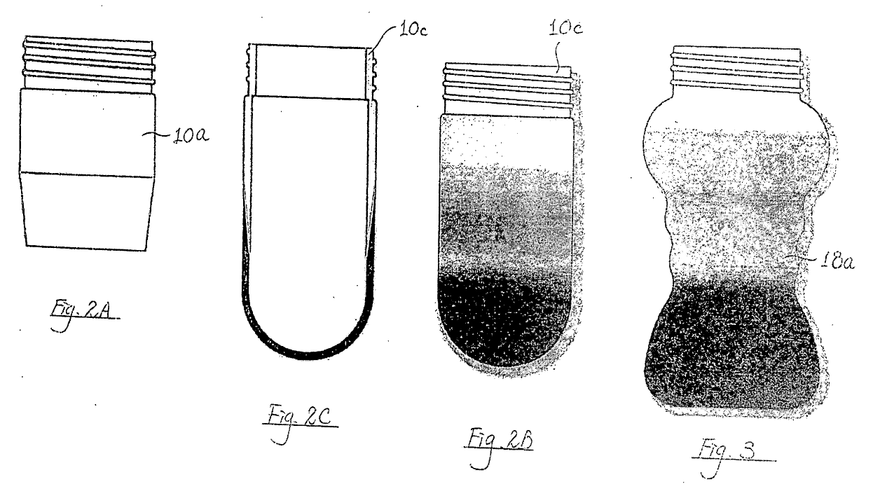

FIGS. 1A to 1D show the steps of a method according to a preferred embodiment of the present invention.

In the step shown in FIG. 1A, a workpiece (also called a “preform”) 10 of a thermoplastic material, e.g. polypropylene (PP) or polycarbonate (PC), is formed by injection molding by an injection molding machine 12. The thermoplastic material may be coloured, e.g. in red, so that the workpiece 10 is also of the same colour.

Subsequently, and as shown in FIG. 1B, the workpiece 10 is over-molded with the thermoplastic material, possibly of a different colour, e.g. green, to form coloured patterns on the outer surface of the workpiece 10 formed in the step shown in FIG. 1A. This step may be carried out by injection molding, double-injection molding (also called “2-shot molding”) or multi-colour injection molding.

The workpiece 10, after undergoing the step shown in FIG. 1B, is heated, as shown in FIG. 1C, by a pre-heating system 14 to raise its temperature to at least the forming temperature of the thermoplastic material, thus allowing the workpiece 10 to be further processed.

The heated workpiece 10 is then positioned in a mold of a stretch blow molding machine 16 to be stretched blow molded, in order to enlarge the volume of the workpiece 10 to form a multi-colour article 18 of a final intended shape and configuration, as defined by the mold. Instead of being carried out by stretch blow molding, this step may also be carried out by blowing, blow molding or vacuum forming.

It can be noted that, by way of such a method, colours and coulored patterns are applied onto the outer surface of the workpiece 10 before final formation of the article 18 into its final intended shape and configuration. As the colours and coloured patterns applied on the workpiece 10 will change during the process of forming the article 18 in its final intended shape and configuration in the step shown in FIG. 1D, irregular and more varied coloured patterns can be formed on the outer surface of the article 18.

The article 18 may be formed with more colours, depending on the number of times of over-molding process (as shown in FIG. 1B) carried out. For example, one may carry out injection molding process two or three times, each with a thermoplastic material of a different colour, or carry out double injection molding a number of times.

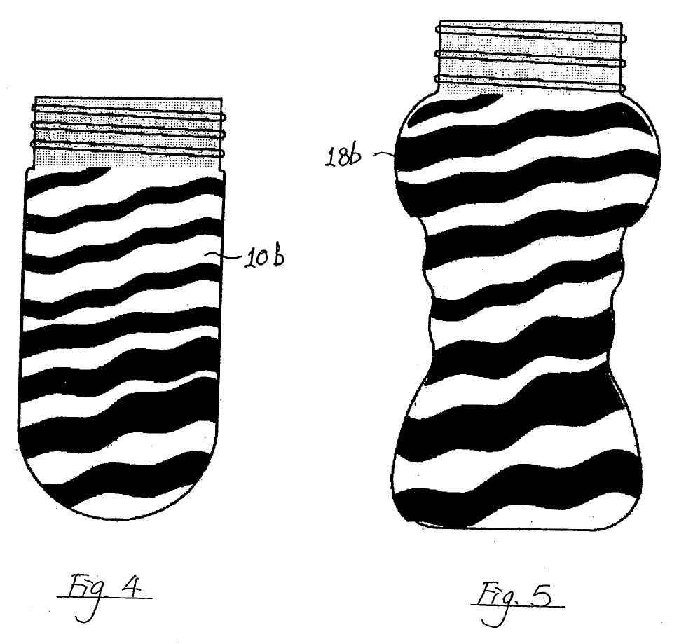

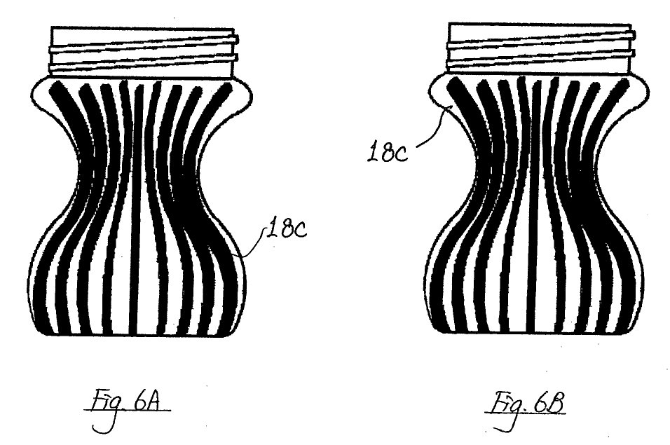

FIG. 2A shows a front view of a preform 10a formed in the step shown in FIG. 1A. The preform 10a is preformed with an open top end and an open bottom end. FIGS. 2B and 2C show, respectively, a front view and a cross-sectional view of a perform 10c after having undergone the step shown in FIG. 1B. The perform 10c is preformed with an open top end and a closed bottom end defining a cavity with a small volume. It can be seen that, upon formation, the final article 18a (being a bottle body) as shown in FIG. 3 is of a cavity with a larger volume. Similarly, the preform 10b (as shown in FIG. 4) is finally formed into a bottle body 18b (as shown in FIG. 5) of a larger volume, and it can be seen that the coloured patterns on the preform 10b is different from that on the bottle 18b finally formed.

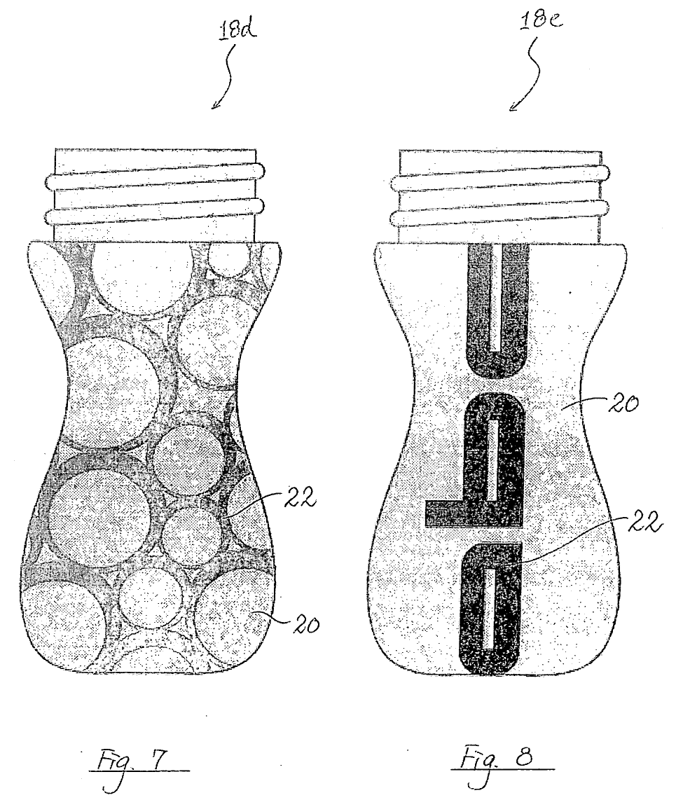

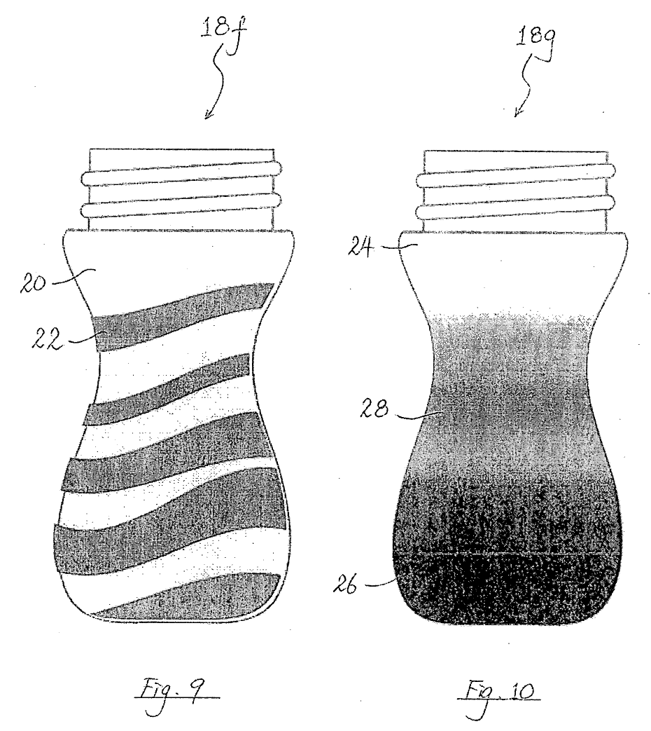

By way of such a method according to the present invention as discussed above, articles of various shapes and coloured patterns may be formed, of which one such article (namely a bottle body) 18c is shown in FIGS. 6A and 6B. FIGS. 7 to 9 show various bottle bodies 18d, 18e, 18f formed of such a method. Each of the bottle bodies 18d, 18e, 18f has a basic background colour 20 on which are formed patterns 22 of a different colour.

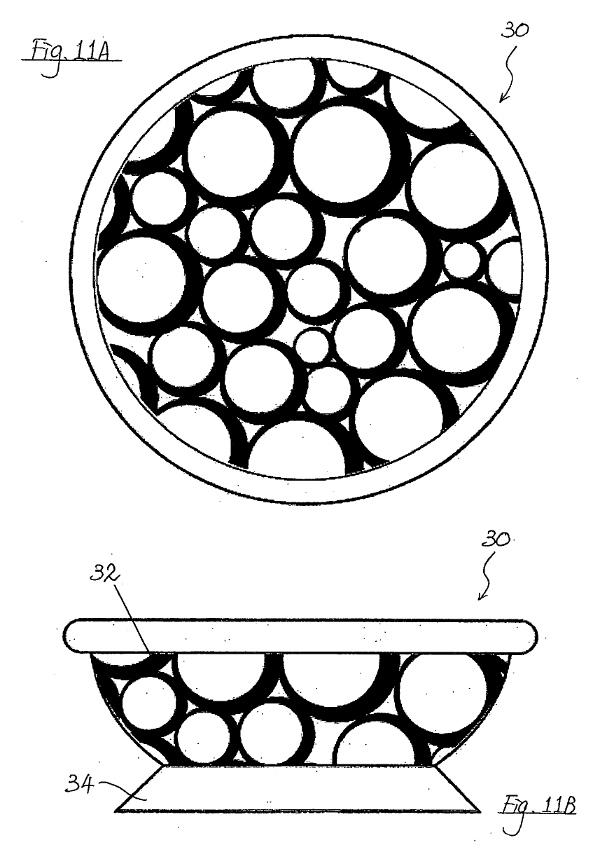

As for FIG. 10, such shows a bottle body 18g with a first colour 24, a second colour 26, and a third colour 28 which is a combination of the first colour 24 and the second colour 26.

The articles formed of a method according to the present invention have so far been described in the context of bottles or bottle bodies. It is of course possible to form other articles by this method. For example, FIGS. 11A and 11B show a container, e.g. a decorative bowl 30, with a container portion 32 and a stand 34 fixed with each other, in which the container portion 32 is a multi-coloured part made by a method according to this invention. Other articles may also be formed, e.g. lampshades and the like.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. A method of forming a thermoplastic article, including the steps of:
(a) forming a workpiece of a thermoplastic material by molding;
(b) applying at least one colour on said workpiece by over-molding at least part of said workpiece with said thermoplastic material of said at least one colour;
(c) raising the temperature of the workpiece to at least the forming temperature of said thermoplastic material; and
(d) enlarging said workpiece.

2. A method according to claim 1 wherein said step (a) is carried out by injection molding.

3. A method according to claim 1 wherein a colour is applied on said workpiece in said step (a).

4. A method according to claim 1 wherein said step (b) is carried out by injection molding, double-injection molding or multi-colour injection molding.

5. A method according to claim 1 wherein said step (b) is carried out a plurality of times for applying a plurality of different colours on said workpiece.

6. A method according to claim 1 wherein said step (d) is carried out by blowing, blow molding, stretch blow molding, or vacuum forming.

7. A method according to claim 1 wherein said thermoplastic material is polypropylene or polycarbonate.
